(19) United States
(12) Patent Application Publication
(10) Pub. No.: US 2024/0313487 A1
(43) Pub. Date: Sep. 19, 2024

(54) MULTI-PIECE COAXIAL PLUG CONNECTOR WITH VARIABLY CONFIGURABLE INTERFACE GEOMETRY

(71) Applicant: MD ELEKTRONIK GmbH, Waldkraiburg (DE)

(72) Inventor: Sabrina SCHNOBRICH, Waldkraiburg (DE)

(73) Assignee: MD ELEKTRONIK GmbH, Waldkraiburg (DE)

(21) Appl. No.: 18/583,239

(22) Filed: Feb. 21, 2024

(30) Foreign Application Priority Data
Mar. 14, 2023 (DE) 10 2023 106 271.9

(51) Int. Cl. H01R 24/38; H01R 13/04; H01R 13/447; H01R 13/639; H01R 43/16; H01R 103/00

(52) U.S. Cl. CPC H01R 24/38; H01R 13/04; H01R 13/447; H01R 13/639; H01R 43/16; H01R 2103/00

(57) ABSTRACT

A coaxial plug connector includes a cable portion and an interface portion. The cable portion has an outer cable contact, a cable insulator and an elongated inner cable contact, the cable insulator is arranged in the outer cable contact, the inner cable contact is spaced apart from the outer cable contact by the cable insulator and the inner cable contact is to be electrically connected to a cable. The interface portion has an outer interface contact, an interface insulator and an elongated inner interface contact, the interface insulator is arranged in the outer interface contact and the inner interface contact is spaced apart from the outer interface contact by the interface insulator. The inner interface contact is accommodated in a central recess in the interface insulator.

### FIELD

The present invention relates to a coaxial plug connector which is constructed from a plurality of pieces and which is variably configurable with regards to an interface geometry. The invention also relates to a method of manufacturing such a coaxial plug connector.

### BACKGROUND

Coaxial plug connectors are used to connect at least two coaxial cables to one another in an electrically conductive manner or to connect a coaxial cable to a coaxial terminal of an appliance, for example. A coaxial cable has an electrically conductive inner conductor, an electrically conductive outer conductor and an intermediate insulation layer between the inner conductor and the outer conductor. The outer conductor generally encloses the inner conductor, but is electrically insulated from the inner conductor by the intermediate insulation layer. Consequently, the outer conductor may serve as shielding, for example to shield the inner conductor against interference from radiated electromagnetic fields. Two coaxial cables may be connected to one another by means of coaxial plug connectors, each of which is attached to one end of one of the coaxial cables, to form a coaxial connection. Therein, both the inner conductors and the outer conductors of the two cables are brought into electrical contact with one another, whilst at the same time it is ensured that there is always sufficient electrical insulation between the inner conductors and the outer conductors within the coaxial connection.

The two coaxial plug connectors are each configured with a complementary interface geometry so that they may be mechanically and electrically coupled together. In terms of the interface geometry, one of the two coaxial plug connectors may be configured as a plug and the other coaxial plug connector may be configured as a matching socket.

Coaxial plug connectors have been proposed that are constructed from a plurality of pieces and in terms of their interface geometry may be variably adapted for different applications. For example, U.S. Pat. No. 10,938,169 B2 describes a coaxial connector composed of a cable portion and an interface portion as well as a method for its manufacture.

### SUMMARY

There may be a need for an alternative and/or improved electrical coaxial plug connector. In particular, there may be a need for a coaxial plug connector that is easy to manufacture, especially on an industrial scale in large quantities. There may also be a need for an alternative and/or improved method of manufacturing such a coaxial plug connector.

Such a need may be met by the subject matter of one of the independent claims. Advantageous embodiments are presented in the dependent claims, the following description and the attached figures.

A first aspect of the invention relates to a coaxial plug connector. The coaxial plug connector has a cable portion and an interface portion. The cable portion has an outer cable contact, a cable insulator, and an elongated inner cable contact. Therein, the cable insulator is arranged in the outer cable contact, the inner cable contact is spaced apart from the outer cable contact by the cable insulator, and the inner cable contact is to be electrically connected to a cable. The interface portion has an outer interface contact, an interface insulator and an elongated inner interface contact. Therein, the interface insulator is arranged in the outer interface contact and the inner interface contact is spaced apart from the outer interface contact by the interface insulator. The inner interface contact is accommodated in a central recess in the interface insulator. The inner interface contact has at least one radially outwardly projecting latching tab, with the inner interface contact being supported in a latching manner by the latching tab on an outer surface of the cable insulator facing the interface portion.

A second aspect of the invention relates to a method of manufacturing a coaxial plug connector according to an embodiment of the first aspect of the invention. The method includes at least the following process steps, preferably, but not necessarily, in the order indicated:
providing the outer cable contact, the cable insulator, the elongated inner cable contact, the outer interface contact, the interface insulator and the elongated inner interface contact; inserting and latching the inner interface contact on the cable insulator; attaching the outer interface contact to the outer cable contact; inserting the interface insulator into the outer interface contact; inserting the inner interface contact, optionally together with the cable insulator attached thereto, into an inner volume in the outer cable contact; inserting the inner cable contact together with a cable connected thereto into the cable insulator accommodated in the outer cable contact and bringing the inner cable contact into contact with the inner interface contact.

By way of introduction, a basic idea and possible advantages concerning embodiments of the invention described herein will be briefly explained, this explanation to be interpreted as merely roughly summarizing and not limiting the invention:

The coaxial plug connector described herein is constructed from a plurality of pieces and comprises at least a cable portion and an interface portion. Both portions consist of an outer contact, an inner contact and an insulator arranged between these two contacts and insulating these two contacts from each other. While the cable portion may always be constructed in the same way for different applications, the interface portion may be differently constructed depending on the application and, in particular, may form different interface geometries. Since the interface portion may be configured for specific applications, i.e. in particular its interface geometry may be adapted to different interface geometries as used in different mating plug connectors for different applications, the coaxial plug connector may easily be adapted for different applications. Therein, only the interface portion or its components need to be modified, whereas the cable portion may remain the same for different applications. When manufacturing the coaxial plug connector, the interface portion may thus be selected from a number of possible interface portions. The interface portion may then be mechanically and electrically connected to the cable portion. A connection between the interface portion and the cable portion should preferably be irreversible, i.e. the interface portion and the cable portion should be non-interchangeably connected so that the interface portion may no longer be separated from the cable portion without damage after the coaxial plug connector has been assembled.

A special feature of the coaxial plug connector proposed herein is that the inner interface contact is accommodated in a central recess within the interface insulator and the inner interface contact has at least one radially outwardly projecting latching tab whereby the inner interface contact is supported in a latching manner on an outer surface of the cable insulator facing the interface portion. With the aid of the one or more latching tabs, the inner interface contact may, inter alia, be pre-fixed to the cable insulator during an assembly process so that the cable insulator and the inner interface contact attached to it may be handled as a unit. This may simplify the assembly process. In addition, the latching tab may provide secure mechanical fixing of the inner interface contact within the coaxial plug connector. Therein, centering and/or fixing of the inner interface contact to the interface insulator may optionally be supported by further measures such as projections to create a mechanical prestress between the inner interface contact and the interface insulator. The projections may take the form of embossings, folds or crush ribs, for example.

Possible embodiments and advantages of embodiments of the coaxial plug connector and a method of manufacturing the same are described in more detail below:

The coaxial plug connector has at least two portions, namely the cable portion and the interface portion, thus it has a multi-piece design. Both the cable portion and the interface portion are each composed of a plurality of components. The cable portion comprises at least one outer cable contact, at least one inner cable contact and at least one cable insulator. The interface portion comprises at least one outer interface contact, at least one inner interface contact and at least one interface insulator. The components of the cable portion may be manufactured or provided separately from the components of the interface portion and only mechanically and electrically connected to them when the coaxial plug connector is assembled.

The term “contact” is used here to refer to an electrically conductive structure or an electrically conductive component. In particular, the contact may be made of metal. For example, the contact, in particular the inner interface contact and/or the inner cable contact, may be a component which is manufactured from a metal sheet by punching and/or bending, i.e. as a punched/bent component. Alternatively, the contact, in particular the outer interface contact and/or the outer cable contact, may be a die-cast component, a punched/bent component or a deep-drawn component. Alternatively, the contact may be configured as a pin, in particular as a solid pin or a hollow pin. Each individual contact may be constructed in one piece, i.e. formed from a single sheet. In principle, however, a single contact may also have a multi-piece structure. The contact may be rigid, in particular more rigid than a cable to be connected to it.

The term “insulator” is used to refer to an electrically insulating structure or an electrically insulating component. In particular, the insulator may consist of an electrically non-conductive material such as a dielectric, especially a plastic. For example, the insulator may be configured as an injection molded component. The insulator may have a one-piece or multi-piece design.

The inner cable contact is elongated. In other words, a dimension of the inner cable contact in a longitudinal direction, that is to say, its length, is greater than a dimension in a transverse direction, that is to say, its width. In particular, the inner cable contact may be straight or pin-like. At a first end, the inner cable contact may be specially configured to connect an end of a cable to the inner cable contact. In particular, provision may be made for connecting an inner conductor of a coaxial cable to the inner cable contact. For this purpose a crimp structure, for example, may be provided at the first end of the inner cable contact, by means of which the inner cable contact may be crimped, for example, to exposed strands of the inner conductor of the cable to be connected. However, the first end of the inner cable contact may alternatively also be connected to the cable to be connected in another way, for example by soldering, welding, bonding, etc. At a second end opposite the first end, the inner cable contact may be configured to interact with the inner interface contact in such a way that an electrically conductive connection is established between the two. In particular, the inner cable contact and the inner interface contact may be geometrically configured in such a way that they may be mechanically plugged together, thereby ensuring good electrical contact between the two components.

The cable insulator is preferably also elongated. The cable insulator may be the same length as or longer or shorter than the inner cable contact. The cable insulator may be configured as a sleeve or it may be sleeve-like. In particular, the cable insulator may be configured as a cylindrical component, i.e. as a tube. The cable insulator may have a circular, rectangular or geometrically differently formed cross-section. The cable insulator may enclose, with a circumferential surface, a radially inner lying, preferably central, elongated cavity. The inner cable contact may be arranged in this cavity. In particular, the cavity may be dimensioned and/or shaped such that the inner cable contact may be inserted at least partially into the cavity of the cable insulator with a precise fit or without play. For this purpose, the outer cross-sectional dimensions of the inner cable contact may be substantially the same size as or only slightly smaller or larger than the inner cross-sectional dimensions of the cavity in the cable insulator. An outer contour of the inner cable contact may be complementary to an inner contour of the cable insulator. In the case of cylindrical cross-sections, an outer diameter of the inner cable contact may therefore be the same size as or slightly smaller or larger than an inner diameter of the cable insulator. The cable insulator may surround or enclose the inner cable contact accommodated in its cavity along its entire length and/or along its entire circumference. The cable insulator is accordingly able to ensure good electrical insulation between the inner cable contact and components lying radially further outwards, in particular the outer cable contact. Therein, the inner cable contact and the cable insulator may be latched together, pressed together or attached to one another in some other way.

The outer cable contact is preferably also elongated. It may be the same length as or longer or shorter than the inner cable contact and/or than the cable insulator. The outer cable contact may serve as a housing for the coaxial plug connector in its cable portion. The outer cable contact may be configured as a sleeve or it may be sleeve-like. In particular, the outer cable contact may be configured as a cylindrical component. The outer cable contact may have a circular, rectangular or geometrically different cross-section. The outer cable contact may enclose, with a circumferential surface, a radially inner lying, preferably central, elongated cavity. The cable insulator may be arranged in this cavity. In particular, the cavity may be dimensioned and/or shaped such that the cable insulator may be inserted at least partially into the cavity of the outer cable contact with a precise fit or without play. For this purpose, the outer cross-sectional dimensions of the cable insulator may be substantially the same size as or only slightly smaller or larger than the inner cross-sectional dimensions of the cavity in the cable insulator. An outer contour of the cable insulator may be complementary to an inner contour of the outer cable contact. In the case of cylindrical cross-sections, an outer diameter of the cable insulator may therefore be the same size as or slightly smaller or larger than an inner diameter of the outer cable contact. The cable insulator and the outer cable contact may be latched together, pressed together, bonded or attached to one another in some other way. The outer cable contact may surround or enclose the cable insulator accommodated in its cavity along its entire length and/or along its entire circumference. The cable insulator is accordingly able to provide good electromagnetic shielding for the inner cable contact accommodated in the cable insulator. At a first end, the outer cable contact may be specially configured to connect the end of the cable to the outer cable contact. In particular, provision may be made for connecting an outer conductor of a coaxial cable to the outer cable contact. For this purpose a crimp structure, for example, may be provided at the first end of the outer cable contact, by means of which the outer cable contact may be crimped, for example, to exposed strands of the outer conductor of the cable to be connected. However, the first end of the outer cable contact may alternatively also be connected to the cable to be connected in another way, for example by soldering, welding, bonding, etc. At a second end opposite the first end, the outer cable contact may be configured to interact mechanically and electrically with the interface portion. In particular, the second end of the outer cable contact may interact with the outer interface contact in such a way that an electrically conductive connection is established between the two. In particular, the outer cable contact and the outer interface contact may be geometrically configured in such a way that they may be mechanically plugged together and/or pressed together, thereby ensuring good electrical contact between the two components.

Overall, the inner cable contact may be arranged radially centrally in the cable portion and extend longitudinally from the first end connected to the cable to the second end connected to the inner interface contact. The inner cable contact runs radially within and preferably coaxially with the cable insulator surrounding it. The cable insulator is in turn accommodated radially within and preferably coaxially with the outer cable contact surrounding it. The cable insulator thus separates the inner cable contact from the outer cable contact both geometrically and electrically.

Components of the interface portion may be of the same or similar design as corresponding components of the cable portion. In particular, the inner interface contact may have the same properties as or similar properties to the inner cable contact, the interface insulator may have the same properties as or similar properties to the cable insulator, and/or the outer interface contact may have the same properties as or similar properties to the outer cable contact. Especially functional properties of the components of the interface portion may be the same as or similar to those of the corresponding components of the cable portion.

However, the geometric configurations of the various components of the interface portion may differ from those of corresponding components of the cable portion. For example, a circumference, a length and/or a contour of the inner interface contact, the interface insulator and/or the outer interface contact may differ from those of corresponding components of the cable portion. In particular, these geometric configurations may be chosen such that the interface portion has a desired interface geometry on its side facing away from the cable portion. This interface geometry is defined, among other things, by a cross-sectional shape, cross-sectional dimensions and/or lengths of the inner interface contact, the interface insulator and/or the outer interface contact, and possibly a positioning of these components relative to one another. The interface geometry at the interface portion may be configured so as to be able to plug the coaxial plug connector with its interface portion together with a mating plug connector that is configured with a correspondingly complementary interface geometry. The interface geometry of the coaxial plug connector may be configured as a plug and the interface geometry of the mating plug connector may be accordingly configured as a socket, or vice versa.

In the finally assembled coaxial plug connector, the inner cable contact is electrically connected to the inner interface contact. This enables an electrical connection from the cable connected to the inner cable contact, particularly in the case of a coaxial cable, from its inner conductor, via the inner cable contact and the inner interface contact, to an inner contact of a mating plug connector plugged together with the coaxial plug connector. Furthermore, the outer cable contact is electrically connected to the outer interface contact. This allows electromagnetic shielding of the inner cable contact and the inner interface contact. In particular, this enables an electrical connection between the cable connected to the outer cable contact, particularly in the case of a coaxial cable from its outer conductor, via the outer cable contact and the outer interface contact to an outer contact of a mating plug connector plugged together with the coaxial plug connector. The cable insulator and the interface insulator ensure that the inner cable contact and the inner interface contact remain spaced apart and electrically insulated from the surrounding outer cable contact and the outer interface contact. The cable insulator and the interface insulator may preferably be configured such that they fill an inner volume of the coaxial plug connector enclosed by the outer cable contact and the outer interface contact preferably completely or at least by more than 90%.

In the coaxial plug connector described herein, a longitudinal direction of extension of the interface portion may run transversely to a longitudinal direction of extension of the cable portion. In other words, the coaxial plug connector may be configured as an angled plug connector. Therein, a longitudinal direction of extension of the cable portion, which generally corresponds to a longitudinal direction of extension of the inner cable contact and the cable connected thereto, may be transverse and preferably perpendicular to a longitudinal direction of extension of the interface portion, which generally corresponds to a longitudinal direction of extension of the inner interface contact and/or an insertion direction in which the coaxial plug connector may be plugged together with a mating plug connector. Such an angled configuration allows the coaxial plug connector to be used advantageously even in confined spaces.

However, the coaxial plug connector described herein may alternatively have a non-angled configuration in which the interface portion and the cable portion are arranged in the same direction or in directions parallel to each other.

A special feature of the coaxial plug connector described herein is that, although the inner interface contact is accommodated within the central recess surrounded by the interface insulator, it is not, or at least not exclusively, fixed to the interface insulator, at least with respect to a direction of movement along its longitudinal direction. Instead, the inner interface contact is provided with a latching tab and this latching tab is configured and arranged such that, with the coaxial plug connector in the assembled state, the inner interface contact is supported in a latching manner by the latching tab on an outer surface of the cable insulator facing the interface portion.

In other words, the latching tab is designed and arranged on the inner interface contact in such a way that it may be pushed into a recess in the cable insulator during an assembly process, for example from one side in an insertion direction that corresponds to the longitudinal direction of the inner interface contact, and, therein, the latching tab temporarily springs radially inwards until the inner interface contact has reached a target position relative to the cable insulator. Therein, the latching tab is positioned in such a way that, when this target position is reached, it may spring radially outwards on an opposite side of the cable insulator and may bear against an outer surface of the cable insulator which extends transversely, in particular orthogonally, to the insertion direction, and may thus be supported there in a latching manner.

Although it is possible that the inner interface contact has only a single latching tab and is supported via this on the cable insulator, it may be advantageous to provide a plurality of latching tabs on the inner interface contact and to arrange and form them in such a way that each of the latching tabs is supported in a latching manner on the outer surface of the cable insulator facing the interface portion.

The latching tabs may be distributed along the circumference of the inner interface contact, in particular symmetrically and/or at equidistant intervals. Each latching tab may be formed in one piece with a remainder of the inner interface contact. In particular, a latching tab may be formed by suitably punching and bending a section of a metal sheet forming the inner interface contact.

According to one embodiment, the latching tab is arranged at a distance from the interface insulator.

In other words, on the one hand the latching tab is arranged and configured on the inner interface contact and on the other hand the cable insulator and the interface insulator adjacent to it are arranged and configured such that, with the coaxial plug connector in the assembled state, the latching tab bears against the cable insulator but remains at a distance from the interface insulator. Therefore, the latching tab is not latched in the interface insulator. For this purpose, a sufficiently large recess may be provided between the interface insulator and the inner interface contact so that the latching tab may spring out radially from the inner interface contact without coming into contact with the interface insulator. This may simplify the assembly process in particular.

According to one embodiment, the cable insulator has, on the outer surface facing the interface portion in an area laterally adjacent to the latching tab, at least one locking frame projecting towards the interface portion which adjoins the latching tab on at least two opposite sides, so that the latching tab is locked on three sides.

In other words, the cable insulator has a contour on its outer surface facing the interface portion which is referred to herein as locking frame. This locking frame protrudes from the rest of the cable insulator in a direction going towards the interface portion. In particular, the locking frame protrudes beyond a surface of the cable insulator on which the latching tab is supported. Viewed in the circumferential direction, the protruding locking frame borders laterally on the area where the latching tab is supported on the cable insulator. Consequently, the locking frame adjoins the latching tab from opposite sides.

As a result, the latching tab lies in a direction corresponding to the longitudinal direction of the inner interface contact against a partial surface of the cable insulator that serves as a stop and faces towards the interface portion, wherein it is laterally limited by the locking frame in a transverse direction perpendicular to the longitudinal direction and therefore is immovable in this direction too. The latching tab together with the inner interface contact connected to it are therefore locked on three sides, i.e. fixed in three spatial directions. The inner interface contact is thus prevented from rotating relative to the cable insulator due to its latching tab, which is laterally limited by the locking frame.

According to a further specific embodiment, the locking frame also adjoins the latching tab from radially outside, so that the latching tab is locked on four sides.

In other words, the contour forming the locking frame and projecting from the cable insulator towards the interface portion may be configured such that, on the one hand, it adjoins the latching tab from both sides in the circumferential direction and, on the other hand, it covers the latching tab in an area radially further out than the latching tab. Therefore, in its latched state on the cable insulator, the latching tab is on the one hand supported on the outer surface of the cable insulator facing the cable portion, and on the other hand is surrounded by the locking frame on three sides running perpendicular to it. The latching tab together with the inner interface contact connected to it are therefore locked on four sides.

Consequently, in its latched state the inner interface contact may not be moved in its longitudinal direction relative to the cable insulator, nor may it be rotated relative to the cable insulator. Furthermore, the latching tab is spaced apart from other components such as the interface insulator by the section of the locking frame that overlaps it further radially outwards, this section of the locking frame also being able to prevent the latched latching tab from being unintentionally unlatched, i.e. released.

According to one embodiment, at least one radially outwardly projecting first projection is formed on the inner interface contact, which bears against an inner surface of the interface insulator under mechanical prestress, and/or at least one radially inwardly projecting second projection is formed on the interface insulator, which bears against an outer surface of the inner interface contact under mechanical prestress.

In other words, in the coaxial plug connector described herein, the inner interface contact may be held clamped within the central recess surrounded by the interface insulator under mechanical prestress, the mechanical prestress being effected by one or more projections projecting from the inner interface contact towards the interface insulator or in the opposite direction. The inner interface contact is accordingly held in the longitudinal direction relative to the cable insulator by the latches of its latching tabs and may also be centered and fixed within the interface insulator by lateral clamping by means of the first and/or second projections provided there.

According to a further specific embodiment, an inseparable connection is established by elastic and/or plastic material displacement between the first projection and an inner surface of the interface insulator and/or between the second projection and an outer surface of the inner interface contact.

In other words, the first and/or second projections may be shaped and/or dimensioned in such a way that elastic and/or plastic material displacement takes place when the inner interface contact is inserted into the recess of the interface insulator. In particular, softer material of the interface insulator, i.e. for example a plastic material forming the interface insulator, may be displaced by a harder material of the inner interface contact. For example, when the inner interface contact is inserted, a harder first projection on the inner interface contact may displace material from the softer interface insulator, thereby leading or contributing to the desired mechanical prestress between the two components. Alternatively or additionally, when the inner interface contact is inserted, softer material of a second projection on the interface insulator may be displaced by the harder inner interface contact and in turn lead to or contribute to the desired mechanical prestress between the two components. The material displacement caused by inserting the inner interface contact into the interface insulator may create an inseparable connection between the two components, i.e. an irreversible connection that may no longer be separated without causing damage.

According to one embodiment, one or more radially outwardly projecting embossings may be formed on the inner interface contact as first projection.

An embossing may here be understood as a section of the inner interface contact where material of the inner interface contact has been locally deformed during a manufacturing process such that it projects radially outwards beyond the other circumferential surface of the inner interface contact. However, the section forming the embossing is connected in all directions to another section of the inner interface contact surrounding it, i.e. there are no local punched-out areas adjacent to the embossing (unlike, for example, in the case of punched-out latching tabs). The embossing may also be referred to as closed embossing. The embossing is thus formed in one piece with a rest of the interface contact. An embossing may therefore also be regarded as a local bulge. For example, the embossing may be shaped like a round stud. Alternatively, the embossing may be elongated and preferably extend in the longitudinal direction of the inner interface contact. For example, an embossing may be created by applying force locally to a metal sheet forming the interface contact. Therein, the embossing projects radially outwards beyond another outer surface of the inner interface contact surrounding the embossing.

Since the material forming the embossing, i.e. for example the locally deformed metal sheet, typically has a higher mechanical load-bearing capacity and/or hardness than the material of the interface insulator, i.e. for example a plastic, when the inner interface contact is inserted into the interface insulator, the embossing may elastically and/or plastically displace sections of the material of the interface insulator and in this way ensure the desired mechanical prestress and, where applicable, an inseparable connection between the two components.

According to one embodiment, a radially outwardly projecting fold may be formed on the inner interface contact as first projection.

A fold may here be understood here as a section of the inner interface contact where material of the inner interface contact has been bent radially outwards during a manufacturing process adjacent to an outer edge or an inner edge of the interface contact. For example, an edge on the outer circumference of a metal sheet from which the inner interface contact is bent may be folded radially outwards to form the fold. Alternatively, a section of the inner interface contact may be punched out in such a way that an outwardly projecting fold is formed on the circumference of a resulting through-hole. The fold may also be described as a punched fold or ridge. The fold is thus preferably formed in one piece with a rest of the interface contact. The fold forms a sharp edge that is directed radially outwards and protrudes beyond the other circumferential surface of the inner interface contact. In particular, the edge forming the fold may be elongated and extend in the longitudinal direction of the inner interface contact. For example, the fold may be created by applying force locally to the edge of a metal sheet forming the interface contact.

Since the material forming the fold, i.e. for example the locally deformed metal sheet, typically has a higher mechanical load-bearing capacity and/or hardness than the material of the interface insulator, when the inner interface contact is inserted into the interface insulator, the fold may elastically and/or plastically displace sections of the material of the interface insulator and in this way ensure the desired mechanical prestress and, where applicable, an inseparable connection between the two components.

According to one embodiment, one or more crush ribs may be formed on the interface insulator as second projection.

A crush rib may here be understood as a section of the interface insulator where material of the interface insulator protrudes radially inwards over another inner surface of the interface insulator. In particular, the crush rib may be designed as an elongated elevation running in the longitudinal direction of the inner interface contact. The crush rib may be formed in one piece with the rest of the interface insulator. For example, when manufacturing the interface insulator, additional material may be provided in the area of the crush rib. In particular, the interface insulator may be configured as an injection-molded component and, therein, additional plastic material may be injected onto the inner surface to form the crush rib, or a mold used during injection molding may be provided with a depression complementary to the crush rib to be formed. The crush rib may be elongated. In particular, the crush rib may extend parallel to the longitudinal direction of the inner interface contact.

Since the material forming the interface insulator, including its one or more crush ribs, typically has a lower mechanical load-bearing capacity and/or hardness than the material of the inner interface contact, the inner interface contact may elastically and/or plastically displace at least sections of the crush rib(s) when inserted into the interface insulator and in this way ensure the desired mechanical prestress and, where applicable, an inseparable connection between the two components.

According to one embodiment, the outer cable contact comprises a first opening, a second opening and a third opening. The first opening is arranged on an end face of the outer cable contact. The second opening is arranged on the outer cable contact at a distance from the first opening. The third opening is formed and arranged on a circumferential surface of the outer cable contact in such a way that, during the assembly process, the cable insulator may be inserted through the third opening into an inner volume in the outer cable contact.

In other words, the outer cable contact of the coaxial plug connector proposed herein may not only have a first opening through which, for example, a connection to a cable may be made, and a second opening through which a connection to the interface portion may be made, but a third opening may additionally be provided on the outer cable contact. The first opening may be arranged and configured in such a way that, during an assembly process, the inner cable contact may be inserted through the first opening in a first insertion direction into an inner volume in the outer cable contact surrounded by a circumferential surface of the outer cable contact. The second opening may be arranged and configured in such a way that the inner interface contact may protrude through the second opening both into the inner volume and into an adjacent space outside the outer cable contact. The third opening may be arranged and configured in such a way that, during the assembly process, the cable insulator may be inserted through the third opening in a second insertion direction into the inner volume in the outer cable contact. The second insertion direction is transverse, preferably perpendicular, to the first insertion direction.

Providing the third opening in the outer cable contact means that, when assembling the coaxial plug connector, the cable insulator does not necessarily have to be inserted through the first opening into the outer cable contact in the longitudinal direction of the inner cable contact to be accommodated therein, i.e. in the first insertion direction. Instead, the cable insulator may be inserted through the third opening into the inner volume in the outer cable contact in the second insertion direction, which is transverse, preferably perpendicular, to this. Therein, the inner interface contact may be attached to the cable insulator beforehand and both may be inserted together as a unit into the inner volume in the outer cable contact.

In other words, according to one embodiment of the manufacturing process proposed herein, the inner interface contact together with the cable insulator attached thereto may be inserted through the third opening of the outer cable contact into the inner volume in the outer cable contact. This may significantly simplify the assembly process.

According to a further specific embodiment, the third opening may be closed by a cover.

The cover preferably closes the entire third opening of the fully assembled coaxial plug connector, i.e. it preferably covers the whole area of the third opening. In other words, the third opening may only be opened during the assembly process and may be closed with the cover as soon as the cable insulator has been accommodated in the outer cable contact. The cover is preferably made of an electrically conductive material and is preferably electrically connected to the outer cable contact. Consequently, the outer cable contact, together with the cover, may form a closed circumferential surface which encloses the inner cable contact and may therefore serve as shielding. The cover may be irreversibly connected to the outer cable contact after the coaxial plug connector has been assembled, meaning that it may not be detached or replaced. For example, the cover may be latched, soldered, welded, bonded or otherwise mechanically connected to the outer cable contact.

According to a further specific embodiment, the second opening and the third opening may lie opposite one another.

Such a configuration may be particularly advantageous if the coaxial plug connector is angled. In this case, the cable insulator may be introduced into the inner volume of the outer cable contact through the third opening. The inner interface contact, which is attached to the cable insulator beforehand or subsequently, may protrude through the second opening towards the interface portion. This may significantly simplify the assembly process.

Overall, according to one embodiment, the method for manufacturing the coaxial plug connector may be configured such that the coaxial plug connector may be manufactured with an interface geometry that is adapted for a specific application, the interface geometry being selected for a plurality of different applications.

For this purpose, according to one embodiment, the interface portion may be configured in an application-specific manner by selecting the outer interface contact, the interface insulator and/or the elongated inner interface contact from a plurality of available respective components such that the interface portion has an application-specific geometry in terms of shape and/or dimensions so as to enter into a mechanical and electrical connection with an application-specific mating plug connector from a plurality of possible mating plug connectors.

Depending on the application, the approach proposed here may therefore be used to easily manufacture coaxial plug connectors with different designs whose interface geometry is adapted to different types of mating plug connectors. While the components of the interface portion to be used may differ depending on the application, the same cable portion may be used for each application, which simplifies the overall complexity of both the coaxial plug connector and the process for manufacturing it.

It should be noted that some of the possible features and advantages of the invention are described herein on the one hand with reference to different embodiments of the coaxial plug connector described herein, and on the other hand with reference to methods of manufacturing the same. A person skilled in the art will recognize that the features may be suitably combined, transferred, adapted or interchanged to arrive at further embodiments of the invention.

### BRIEF DESCRIPTION OF DRAWINGS

Advantageous embodiments of the invention are further explained below with reference to the accompanying drawings, in which neither the drawings nor the explanations are to be construed as limiting the invention in any way.

FIG. 1 shows a perspective cross-sectional view through a coaxial plug connector according to a first embodiment of the present invention.

FIG. 2 shows a longitudinal sectional view in a horizontal plane along an interface region and through an adjacent cable region of the coaxial plug connector from FIG. 1.

FIG. 3 shows a perspective cross-sectional view through a coaxial plug connector according to a second embodiment of the present invention.

FIG. 4 shows a longitudinal sectional view in a vertical plane along an interface region and through an adjacent cable region of the coaxial plug connector from FIG. 3.

FIG. 5 shows a longitudinal sectional view in a vertical plane along an interface region and through an adjacent cable region of a coaxial plug connector according to a third embodiment of the present invention.

FIG. 6 shows a longitudinal sectional view in a horizontal plane along the interface region and through the adjacent cable region of the coaxial plug connector from FIG. 5.

FIG. 7 shows a perspective view of an inner interface contact provided with embossings for a coaxial plug connector according to the invention.

FIG. 8 shows a perspective view of an inner interface contact provided with folds for a coaxial plug connector according to the invention.

FIG. 9 shows a perspective view of an interface insulator provided with a crush rib of a coaxial plug connector according to the invention.

FIG. 10 shows a unit to be preassembled during a manufacturing process comprising a cable insulator and an inner interface contact for insertion into an outer cable contact of a coaxial plug connector according to an embodiment of the present invention.

The figures are merely schematic and not to scale. Identical reference numbers in the different drawings denote identical or identically acting features.

### DETAILED DESCRIPTION

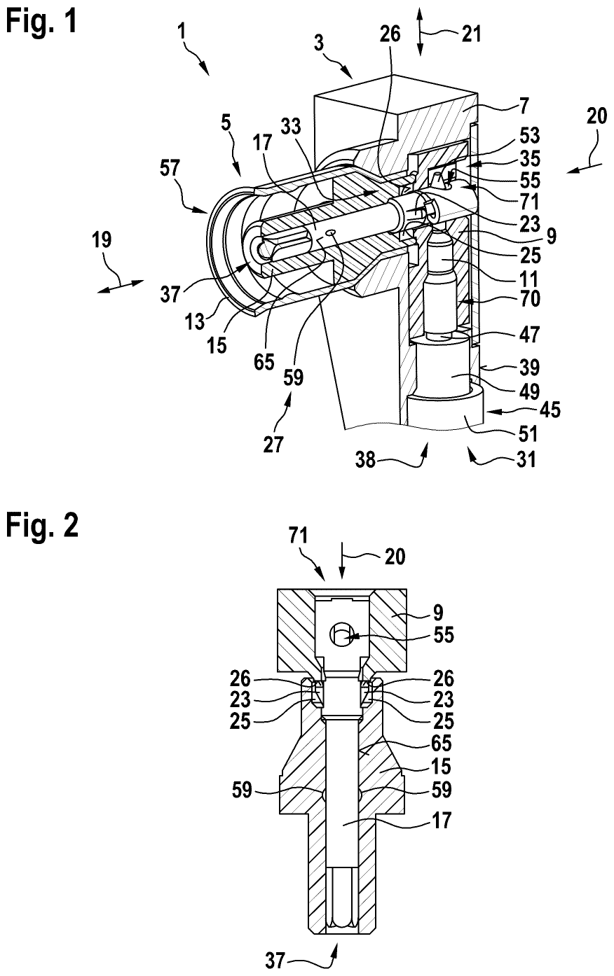

FIG. 1 illustrates a coaxial plug connector 1 according to a first embodiment. FIG. 2 shows a longitudinal sectional view in a horizontal plane through the coaxial plug connector 1.

The coaxial plug connector 1 comprises a cable portion 3 and an interface portion 5. In the example shown, the coaxial plug connector 1 is configured as an angled plug connector, i.e. a longitudinal direction of extension 19 of the interface portion 5 runs perpendicular to a longitudinal direction of extension 21 of the cable portion 3.

The cable portion 3 has an outer cable contact 7, a cable insulator 9 and an elongated inner cable contact 11. The outer cable contact 7 is a die-cast component and the inner cable contact 11 is a punched/bent component made from an electrically conductive metal sheet. The cable insulator 9 is configured as a plastic component. The cable insulator 9 is accommodated in an inner volume surrounded by the outer cable contact 7. The inner cable contact 11 is accommodated coaxially in a central recess 70 extending in the longitudinal direction of extension 21 of the cable portion 3 within the cable insulator 9, and via the latter it is spaced apart from the outer cable contact 7 in the radial direction and thus electrically insulated. The cable insulator 9 also has a central upper recess 71 running in the transverse direction of the cable portion 3. In the example shown, the inner cable contact 11 is configured as a sleeve tapering from a first end to a second end, which forms a tip 53 at the second end. At the first end, the inner cable contact 11 is connected to an inner conductor 47 of a coaxial cable 45. For this purpose, the inner cable contact 11 with its first end and the inner conductor 47 may be crimped together, for example. An outer conductor 51 of the coaxial cable 45 is connected to the outer cable contact 7, also via a crimp, for example. On the cable 45 there is an insulation layer 49 between the outer conductor 51 and the inner conductor 47 which electrically separates the two conductors from each other.

The interface portion 5 has an outer interface contact 13, a interface insulator 15 and an elongated inner interface contact 17. The outer interface contact 13 is a deep-drawn component, the inner interface contact 17 is again configured as punched and bent component and the interface insulator 15 as a plastic component. The inner interface contact 17 is accommodated in a central recess 37 coaxially within the interface insulator 15 and via the latter it is spaced apart from the outer interface contact 13 in the radial direction and thus electrically insulated.

The outer interface contact 13, the interface insulator 15 and the inner interface contact 17 are configured in terms of their geometric design, i.e. in particular with regard to their dimensions and shapes, such that they form an interface geometry 57 at a free end facing away from the cable portion 3, which is configured such that the coaxial plug connector 1 may be plugged together via its interface portion 5 with a correspondingly complementary interface geometry of a mating plug connector (not shown).

In the embodiment shown, the cable portion 3 of the coaxial plug connector 1 has an elongated shape in which a first circular opening 31 is formed in a lower region on a lower end face 38 of the outer cable contact 7. The outer cable contact 7 has a box-shaped geometry and surrounds the first opening 31 in the form of a sleeve-like wall. The likewise circular cable 45, together with the inner cable contact 11 attached to it, is inserted into the lower area via the first opening 31 in an insertion direction (i.e. from bottom vertically to top in the figure shown).

At a distance from the first opening 31, the outer cable contact 7 has a second opening 33 in an upper area on a circumferential surface 39. In the example shown, the second opening 33 is circular. In the upper area, the outer cable contact 7 is configured as a housing with a rectangular cross-section. The second opening 33 serves to create an internal connection between the cable portion 3 and the interface portion 5, which is shielded from the outside by the external cable contact 7 and the external interface contact 13. In this case, the inner interface contact 17 extends through the second opening 33 from a section facing towards the interface geometry 57 to a section accommodated in the inner volume in the outer cable contact 7. The outer interface contact 13 is mechanically and electrically connected to the outer cable contact 7. In particular, both outer contacts 13, 7 may be mechanically connected to each other in a non-detachable manner, for example by pressing, in such a way that they may no longer be separated from one another without causing damage once the coaxial plug connector 1 has been finally manufactured.

Also at a distance from the first opening 31, the outer cable contact 7 has a third opening 35 in an upper area on the circumferential surface 39. In the example shown, the third opening 35 is formed opposite the second opening 33 in the circumferential surface 39 of the outer cable contact 7. The third opening 35 is rectangular in the example shown. It has a width that substantially corresponds to a width of the outer cable contact 7 in the upper area or is slightly smaller than this. Therein, the width of the third opening 35 is equal to or greater than the width of the cable insulator 9 to be accommodated in the inner volume of the outer cable contact 7. A length of the third opening 35 is considerably greater than its width and in particular is the same length as or longer than a length of the cable insulator 9. In the finally assembled coaxial plug connector 1, the third opening 35 is closed with an electrically conductive cover 41. Consequently, the housing formed by the outer cable contact 7 then completely encloses the inner volume together with the cable insulator 9 accommodated therein and the inner cable contact 11 extending therein as well as at least a section of the inner interface contact 17 projecting into the inner volume, with the exception of the first and second openings 31, 33.

The inner interface contact 17 has a rear length portion which is located within the cable portion 3 in the inner volume of the outer cable contact 7 where it extends through the central upper recess 71 in the cable insulator 9 running in the transverse direction of the cable portion 3. The inner interface contact 17 further has a front length portion which is located within the interface portion 5 within an inner volume surrounded by the outer interface contact 13, where it is accommodated in the central recess 37 in the interface insulator 15.

In order to fix the inner interface contact 17 within the coaxial plug connector 1, in particular in its longitudinal direction 19, in the first embodiment shown in FIGS. 1 and 2, two latching tabs 23 projecting laterally are formed on opposite sides of the inner interface contact 17. These latching tabs 23 project radially outwards over an outer surface 65 of the inner interface contact 17. The latching tabs may, for example, temporarily spring radially inwards during insertion of the inner interface contact 17 into the central recess 37 of the interface insulator 15. When a target position is reached, the latching tab 23 may then engage in a recess 25, which is provided in an area where the interface insulator 15 adjoins the cable insulator 9. Alternatively, the inner interface contact 17 may be attached to the cable insulator 9 beforehand by pushing it into its central upper recess 71 running in the transverse direction, the latching tabs 23 temporarily springing in and then springing out when the target position is reached. In a latched state, a stop surface of each of the latching tabs 23 facing towards the cable insulator 9 is in contact with an outer surface 26 of the cable insulator 9 facing towards the interface portion 5 and is thus supported on the latter in a latching manner. Therein, the outer surface 26 of the cable insulator 9 facing towards the interface portion 5 runs orthogonally to the longitudinal direction 19 of the inner interface contact 17. Consequently, the inner interface contact 17 is prevented by the latching caused by the latching tabs 23 from being moved out of the cable insulator 9 against an insertion direction 20 in which the inner interface contact 17 is inserted into the upper recess 71 in the cable insulator 9 during assembly.

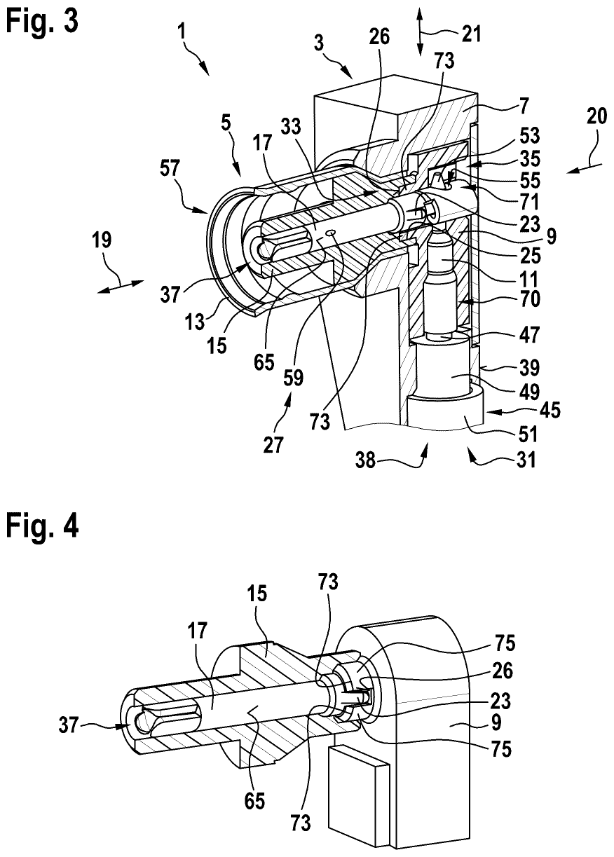

FIGS. 3 and 4 show a modified embodiment of the coaxial plug connector 1. Many of the features and details of the coaxial plug connector 1 according to the embodiment described above are configured in the same or a similar way. However, in this embodiment, a projecting locking frame 73 is also formed on the cable insulator 9 on the outer surface 26 facing the interface portion 5. The locking frame 73 has two locking frame areas 75, each of which is laterally adjacent to one of the latching tabs 23 on opposite sides. Thus, in its latched state, each latching tab, on the one hand, abuts the outer surface 26 of the cable insulator 9, which faces in the opposite direction to the cable insulator 9, with its stop surface facing towards the cable insulator 9, and, on the other hand, is additionally held on its sides extending transversely to the stop surface by the adjacent locking frame areas 75. Each latching tab 23 is therefore locked on three sides in total. Due to this locking, the inner interface contact 17 is held in a desired position and prevented from twisting.

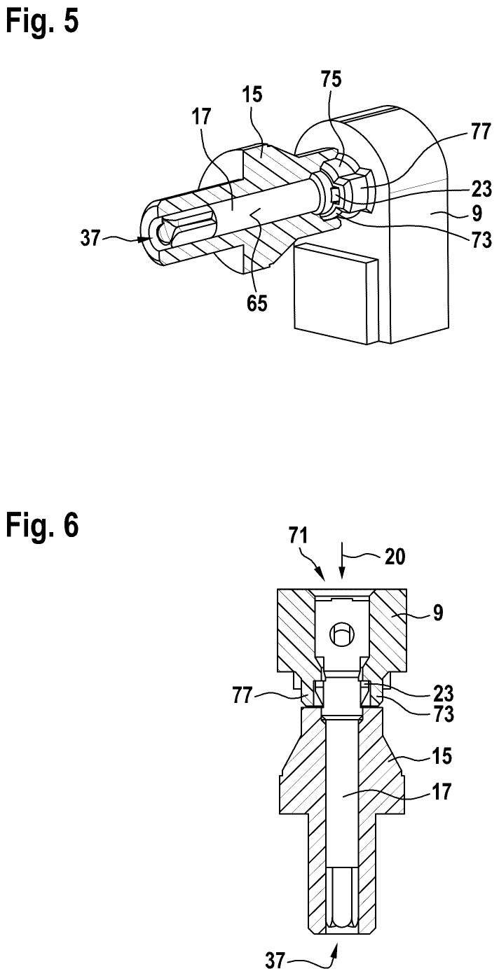

FIGS. 5 and 6 show components of a coaxial plug connector 1 according to a further embodiment. Here, the locking frame 73 provided on the cable insulator 9 has a further locking frame area 77. The further locking frame area 77 adjoins the latching tab 23 radially from outside and thus covers it. Consequently, the latching tab 23 is locked on four sides.

In all described embodiments, each of the latching tabs 23 is arranged at a distance relative to the interface insulator 15. In particular, each latching tab 23 is arranged in the radial direction at a distance from a section of the interface insulator 15 that surrounds it radially further out. Hence, there is no direct mechanical contact between the latching tabs 23 and the interface insulator 15. Consequently, the inner interface contact 17 with its latching tabs 23 is latched only to the cable insulator 9, but not to the interface insulator 15.

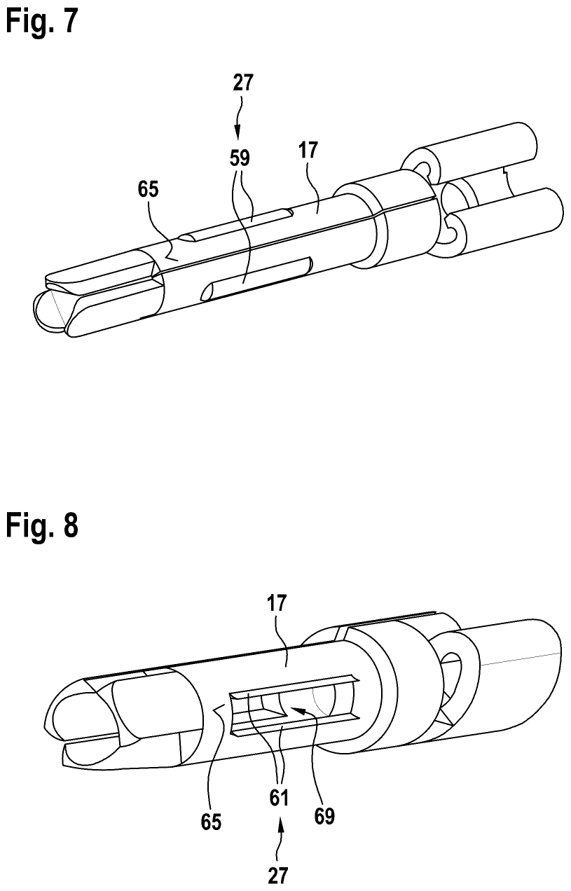

Supplementary measures may be provided to center and/or fix the inner interface contact 17 within the recess 37 in the interface insulator 15. In particular, as illustrated in FIGS. 7, 8 and 9, one or more radially outwardly projecting second projections 27 may be formed on the inner interface contact 17 and/or one or more radially inwardly projecting second projections 29 may be formed on the interface insulator. By means of the first projections 27, the inner interface contact 17 may bear against an inner surface 67 of the interface insulator 15 under mechanical prestress. Alternatively or additionally, the interface insulator 15 may bear against the outer surface 65 of the inner interface contact 17 via the second projections 29.

In the example shown in FIG. 7, several radially outwardly projecting first projections 27 in the form of embossings 59 are formed on the inner interface contact 17. The embossings 59 have an elongated contour so that they are rib-shaped. The elongated embossings 59 run parallel to the longitudinal direction 19 of the inner interface contact 17. The embossings 59 are each arranged at different positions along the circumference of the inner interface contact 17, in particular symmetrically and/or equidistantly spaced from one another. The embossings 59 form elevations or bulges protruding on an outer surface 65 of the inner interface contact 17.

Therein, the embossings 59 are configured and dimensioned such that they bear against the inner surface 67 of the interface insulator 15 under mechanical prestress. In other words, in the area of the embossings 59, the inner interface contact 17 has outer dimensions that are at least slightly larger than the inner dimensions of the interface insulator 15 surrounding it. Consequently, the embossings 59 may press into the softer material of the interface insulator 15 due to the typically harder material of the inner interface contact 17 and cause local elastic and/or plastic material displacement. As a result, the inner interface contact 17 may be held on the interface insulator 15 and, after assembly of the coaxial plug connector 1, preferably form a connection with it that is no longer reversibly detachable.

FIG. 8 illustrates a variant of the inner interface contact 17 with a plurality of folds 61 as first projections 27. The folds 61 are formed as punched folds adjacent to punched openings 69. The folds 61 project radially outwards from an outer surface 65 of the inner interface contact 17 towards the inner surface 67 of the surrounding interface insulator 15.

When assembling the coaxial plug connector 1, each of the folds 61 may bear against the inner surface 67 of the interface insulator 15 under mechanical prestress when the inner interface contact 17 is inserted into the central recess 37 of the interface insulator 15, thereby centering and fixing the inner interface contact 17 on the interface insulator 15. The folds 61 may locally displace material of the interface insulator 15 and ensure an inseparable connection between the inner interface contact 17 and the interface insulator 15.

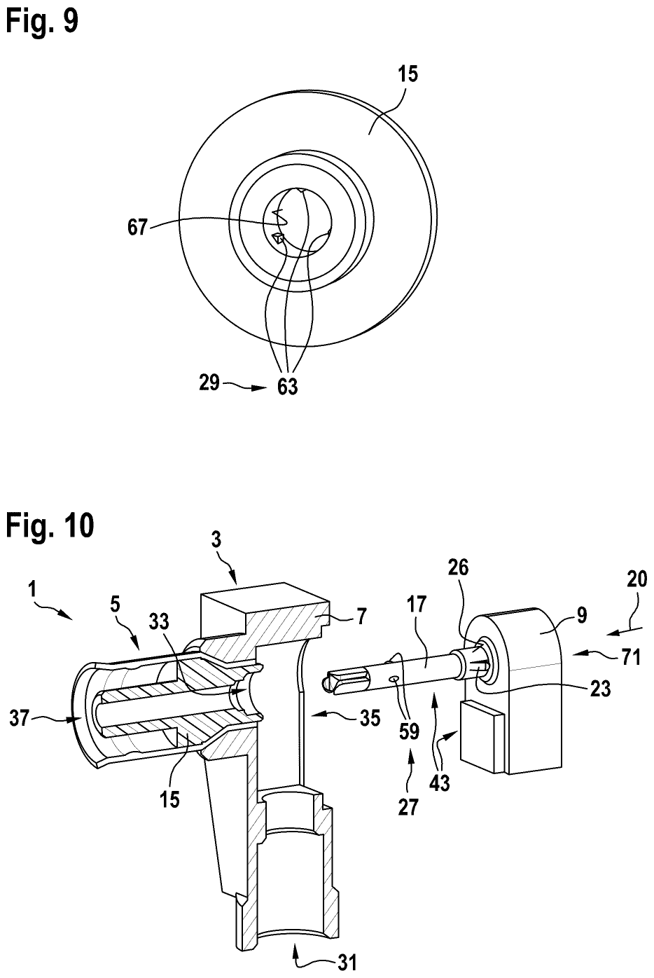

FIG. 9 illustrates an interface insulator 15 provided with crush ribs 63 as second projections 29. The crush ribs 63 protrude as elongated structures from the inner surface 67 of the interface insulator 15 towards the inner interface contact 17. The crush ribs 63 are arranged and dimensioned in such a way that they bear against the outer surface 65 of the inner interface contact 17 under mechanical prestress and in this way center and fix the inner interface contact 17.

When the inner interface contact 17 is inserted into the recess 37 of the interface insulator 15, the harder inner interface contact 17 may elastically and/or plastically deform and/or displace the softer material of the crush ribs 63 and in this way ensure a firm, preferably inseparable connection between the inner interface contact 17 and the interface insulator 15.

Finally, a possible embodiment of a method for manufacturing the coaxial plug connector 1 is explained with reference to the figures described above and to the supplementary FIG. 10.

First, all components of the coaxial plug connector 1 are provided.

Then, in a preparatory step, the inner interface contact 17 is attached to the cable insulator 9. For this purpose, the inner interface contact 17 is inserted into the central upper recess 71 in the cable insulator 9 in the insertion direction 20, which corresponds to its longitudinal direction of extension 19, and moved to a target position. When the target position is reached, the latching tabs 23, which were previously deflected inwards, may spring radially outwards and, in doing so, latch onto the outer surface 26 of the cable insulator 9 which faces towards the interface portion 5. In this configuration, the inner interface contact 17 is thus fixed to the cable insulator 9 so that both may be handled together as a unit 43.

In particular, this unit 43 may be introduced into the inner volume in the outer cable contact 7. For this purpose, the unit 43 may be inserted through the large third opening 35 on a rear side of the outer cable contact 7 into the inner volume (i.e. coming from the right in FIG. 10), with the inner interface contact 17 on the opposite front side of the outer cable contact 7 projecting outwards through the second opening 33 provided there.

The inner cable contact 11 together with the cable 45 previously attached to it may then be pushed through the first opening 31 into the cable insulator 9 already located in the inner volume in the outer cable contact 7, for example from below. Therein, the inner cable contact 11 may be pushed in until its tip 53 engages in a through-hole 55 near the rear end of the inner interface contact 17, thereby bringing the inner cable contact 11 into electrical contact with the inner interface contact 17.

The outer interface contact 13 may be attached to the outer cable contact 7 subsequently, simultaneously or beforehand. The interface insulator 15 may be introduced into the outer interface contact 13 or between the outer interface contact 13 and the inner interface contact 17 beforehand, simultaneously or afterwards. The outer interface contact 13 and/or the interface insulator 15 may be introduced into the second opening 33 in the outer cable contact 7 and irreversibly pressed together with the latter, for example. Therein, the pre-assembled inner interface contact 17, which already projects from the cable section 3 through the second opening 33 towards the interface portion 5, may be inserted into the central recess 37 in the interface insulator 15. The first projections 27 protruding from the inner interface contact 17 and/or the second projections 29 protruding from the interface insulator 15 may be elastically and/or plastically deformed or displaced, thereby ensuring that the inner interface contact 17 is centered and fixed in the interface insulator 15.

It should be noted that the inner interface contact 17 and the cable insulator 9 do not necessarily have to be preassembled in order to form the unit 43. In a possible alternative assembly process, the cable insulator 9 may instead first be inserted through the third opening 35 into the inner volume within the outer cable contact 7, and only then is the inner interface insulator 17 introduced in the insertion direction 20 into the transversely running central upper recess 71 in the cable insulator 9, and then latched when the target position is reached.

Finally, it pointed out that terms such as “having”, “comprising” etc. do not exclude other elements or steps, and terms such as “one” or “a” do not exclude a plurality. It should further be noted that features or steps that have been described with reference to one of the above embodiments may also be used in combination with other features or steps of other embodiments described above. Reference numbers in the claims are not to be considered as limitations.

### LIST OF REFERENCES

1 Coaxial plug connector
3 Cable portion
5 Interface portion
7 Outer cable contact
9 Cable insulator
11 Inner cable contact
13 Outer interface contact
15 Interface insulator
17 Inner interface contact
19 Longitudinal direction of extension of the interface portion
20 Insertion direction of the inner interface contact
21 Longitudinal direction of extension of the cable portion
23 Latching tab
25 Recess
26 Outer surface of the cable insulator facing the interface portion
27 First projection
29 Second projection
31 First opening
33 Second opening
35 Third opening
37 Central recess in the interface insulator
38 Bottom end face of the outer cable contact
39 Circumferential surface of the outer cable contact
41 Cover
43 Unit
45 Cable
47 Inner conductor
49 Insulation layer
51 Outer conductor
53 Tip of the inner cable contact
55 Through-hole in the inner interface contact
57 Interface geometry
59 Embossing
61 Fold
63 Crush rib
65 Outer surface of the inner interface contact
67 Inner surface of the interface insulator
69 Punched opening at inner interface contact
70 Central recess on the cable insulator running in the longitudinal direction
71 Central upper recess on the cable insulator running in the transverse direction
73 Locking frame
75 Locking frame area
77 Further locking frame area

1. A coaxial plug connector, comprising:
a cable portion and an interface portion,
wherein the cable portion has an outer cable contact, a cable insulator and an elongated inner cable contact, the cable insulator is arranged in the outer cable contact, the inner cable contact is spaced apart from the outer cable contact by the cable insulator, and the inner cable contact is to be electrically connected to a cable;
wherein the interface portion comprises an outer interface contact, an interface insulator and an elongated inner interface contact, the interface insulator is arranged in the outer interface contact and the inner interface contact is spaced apart from the outer interface contact by the interface insulator,
wherein the inner interface contact is accommodated in a central recess in the interface insulator,
wherein the inner interface contact has at least one radially outwardly projecting latching tab, and
wherein the inner interface contact is supported in a latching manner by the latching tab on an outer surface of the cable insulator facing the interface portion.

2. The coaxial plug connector according to claim 1,
wherein the latching tab is arranged at a distance from the interface insulator.

3. The coaxial plug connector according to claim 1,
wherein the cable insulator has, on the outer surface facing the interface portion in an area laterally adjacent to the latching tab, at least one locking frame projecting towards the interface portion which adjoins the latching tab on at least two opposite sides, so that the latching tab is locked on three sides.

4. The coaxial plug connector according to claim 1,
wherein the locking frame also adjoins the latching tab from radially outside, so that the latching tab is locked on four sides.

5. The coaxial plug connector according to claim 1,
wherein at least one of the following conditions applies:
at least one radially outwardly projecting first projection is formed on the inner interface contact which bears against an inner surface of the interface insulator under mechanical prestress,
at least one radially inwardly projecting second projection is formed on the interface insulator which bears against an outer surface of the inner interface contact under mechanical prestress.

6. The coaxial plug connector according to claim 5,
wherein an inseparable connection is established by a least one of elastic and plastic material displacement at least one of between the first projection and the inner surface of the interface insulator and between the second projection and the outer surface of the inner interface contact.

7. The coaxial plug connector according to claim 5,
wherein a radially outwardly projecting embossing is formed on the inner interface contact as first projection.

8. The coaxial plug connector according to claim 5,
wherein a radially outwardly projecting fold is formed on the inner interface contact as first projection.

9. The coaxial plug connector according to claim 5,
wherein a radially inwardly projecting crush rib is formed on the interface insulator as second projection.

10. The coaxial plug connector according to claim 1,
wherein the outer cable contact has a first opening, a second opening and a third opening,
wherein the first opening is arranged on an end face of the outer cable contact, wherein the second opening is arranged on the outer cable contact at a distance from the first opening, and
wherein the third opening is formed and arranged on a circumferential surface of the outer cable contact in such a way that, during the assembly process, the cable insulator may be inserted through the third opening into an inner volume in the outer cable contact.

11. The coaxial plug connector according to claim 10,
wherein the third opening is closed by a cover.

12. The coaxial plug connector according to claim 10,
wherein the second opening and the third opening lie opposite one another.

13. A method of manufacturing a coaxial plug connector according to claim 1, wherein the method comprises:
providing the outer cable contact, the cable insulator, the elongated inner cable contact, the outer interface contact, the interface insulator and the elongated inner interface contact;
inserting and latching the inner interface contact on the cable insulator;
attaching the outer interface contact to the outer cable contact;
inserting the interface insulator into the outer interface contact;
inserting the inner interface contact, optionally together with the cable insulator attached thereto, into an inner volume in the outer cable contact;
inserting the inner cable contact together with a cable connected thereto into the cable insulator accommodated in the outer cable contact and bringing the inner cable contact into contact with the inner interface contact.

14. The method according to claim 13,
wherein the method comprises:
inserting the inner interface contact together with the cable insulator attached thereto through the third opening of the outer cable contact into the inner volume in the outer cable contact.

15. The method according to claim 13,
wherein the interface portion is configured in an application-specific manner by selecting at least one of the outer interface contact, the interface insulator and the elongated inner interface contact from a plurality of available respective components such that the interface portion has an application-specific interface geometry in terms of at least one of shape and dimensions so as to enter into a mechanical and electrical connection with an application-specific mating plug connector from a plurality of possible mating plug connectors.
